(19) United States
(12) Patent Application Publication
(10) Pub. No.: US 2025/0130333 A1
(43) Pub. Date: Apr. 24, 2025

(54) ANTENNA WITH SPOOF DETECTION

(71) Applicant: Drone Defence Services Limited, Retford (GB)

(72) Inventors: Richard GILL, Newark (GB); Henry WILLSON, Sheffield (GB)

(73) Assignee: Drone Defence Services Limited, Retford (GB)

(21) Appl. No.: 18/423,889

(22) Filed: Jan. 26, 2024

(30) Foreign Application Priority Data
Oct. 19, 2023 (GB) 2315105.3

(51) Int. Cl. G01S 19/21; H01Q 1/52

(52) U.S. Cl. CPC G01S 19/215; H01Q 1/521

(57) ABSTRACT

The present invention provides a directional sensor for receiving and evaluating location signals from aerial vehicles relative to the sensor. The sensor may include aerials, means for receiving signals from the aerials, and a process for processing the signals. The processor may be configured to: (a) determine for a given input signal a differential of a signal parameter between two or more of the aerials; (b) operate on the differential signal parameter to a determined position relative to the aerials by means of a correlation or covariance; (c) compare the determined position relative to the aerials with a reported position; (d) determine a difference between the reported and determined positions and compare this to an equivalence criteria; and (e) upon carrying out the determination where the difference does not match the equivalence criteria to report a spoofing attempt.

### CROSS-REFERENCE TO RELATED APPLICATION

This application claims priority to United Kingdom Patent Application No. 2315105.3, filed Oct. 19, 2023, the disclosure of which is incorporated herein by reference in its entirety.

### TECHNICAL FIELD

The present invention relates to an antenna with spoof detection, such as may be used for air traffic control of micro air traffic and to the air traffic control of micro aerial vehicles.

### BACKGROUND

Technological miniaturization has caused the diversification of aerial vehicles in both size and purpose. Manned, remote controlled and autonomous vehicles simultaneously operate. Alongside traditional airplanes and helicopters, quadcopters and insectoid aerial vehicles fill different roles.

Historical, manpower, fuel and carbon intensive processes, for example delivery by postman and van, or less capable systems including static surveillance camera are being substituted with unmanned aerial vehicles.

Unmanned aerial vehicle (UAV) or drones finding increased use can be expected to lead to a more congested airspace, with more aerial vehicles. This leads to an increased potential for both unintentional failings, including collisions, and malicious behavior. This is both a risk both between aerial vehicles and with the surroundings.

A specific problem arises in terms of effective air traffic control with micro air traffic in that position determination by means such as radar is generally ineffective, particularly in built-up environments and with high concentrations, particularly as predicted, for such micro aerial traffic. As such, Automatic Dependent Surveillance-Broadcast (ADS-B) and variants thereof needs to be relied upon. ADS-B is a surveillance technology that uses GPS (Global Positioning System) to determine an aircraft's precise position and then broadcasts that information to ground stations and other aircraft equipped with ADS-B receivers. This allows air traffic controllers to have a more accurate and real-time view of aircraft positions, which enhances situational awareness and safety in the airspace. ADS-B is becoming a standard in modern air traffic management systems worldwide, as it provides improved efficiency, reduced separation standards, and more comprehensive traffic information for both pilots and controllers.

However, this system relies upon accurate reporting from aircraft. Various occasions arise where inaccurate reports may be provided. There are a variety of circumstances where this occurs and most obviously where there is malicious intent or a military motivation. It is therefore important to have means to detect when such spoofing occurs. Spoofing is where erroneous information is provided with an intention to deceive. In particular, where the erroneous information appears to be valid but is intentionally invalid.

Spoofing can be addressed by comparing the erroneous information received with validated information and noting a discrepancy.

These challenges present particular problems with micro aerial vehicles and these problems require means to address them.

Further, any system to mitigate such spoofing must itself be defended against exploitation lest false information inhibit operations.

In addition to large number of elements, the quick and often erratic movement thereof must be comprehended.

### SUMMARY

Aspects of the present invention may provide a directional sensor for receiving and evaluating location signals from aerial vehicles relative to the sensor. The sensor may include a plurality of aerials, means for receiving signals from the aerials, and the signals may be processed by a processor. The processor may be configured to: determine for a given input signal a differential of a signal parameter between two or more of the aerials. This may be achieved when the signal received at any given time instance is comparable in magnitude in the time domain, and differences in magnitude may reflect signal attenuation.

While aspects of the present invention may provide a direction sensor, aspects of the present invention may provide a combination of direction and distance, i.e. position sensing. Therefore, aspects of the present invention may be described as a position sensor for receiving and evaluating location signals, when the distance function is also utilized.

For the purposes of the present invention, both “aerial” and “antenna”, as nouns, are synonymous and refer to the equipment used in radio communications to transmit and receive radio waves. The physical element for electromagnetic radiation reception and transmission is shown in the diagrams, but, in aspects of the present invention, the supporting hardware for amplification decoding and processing should be taken as implicitly present.

“aerial”, as an adjective, as in the context of “aerial vehicle” refers to “in or of the air” as this is where such vehicles operate; aerial vehicles commonly have antenna, as described, however this is not eponymous and is not necessarily required.

In some aspects, the aerials of the directional sensor may include a Log-periodic antenna or a Yagi-Uda antenna element. In some aspects, all antenna elements may be of the same type.

In some aspects, the antenna may be a log periodic antenna as, in the present application, a log periodic antenna has been found to give good signal reception for both the 2.4 and 5 GHz bands combined with similar gain at the two frequencies coupled with lower noise than other antenna types.

However, in some situations, a Yagi-Uda antenna element may be used (e.g., where one or other of the 2.4 or 5 GHz bands is to be measured as better frequency selectivity can be obtained). In some aspects, Yagi-Uda antennas may be used with multiple antenna elements such as six or more in various directions as these antenna elements can be highly directional with narrow beam width. The above are suitable for the directional sensor of the present invention were differences in signal reception between aerials may be the primary determinant rather than antenna element direction.

For clarity, the term antenna element is used here to connote the actual physical reception element.

In some aspects, the present invention may operate on the differential signal parameter to a determined position relative to the aerials by means of a correlation or covariance.

In some aspects, the present invention may compare the determined position relative to the aerials with a reported position; position may be in terms of direction and/or distance. In some aspects, position may be in terms of direction and distance from the directional sensor. In some aspects, direction may be provided using any convenient metric such as angle compared to true North.

In some aspects, the present invention determines a difference between the reported and determined positions and compare this to equivalence criterion; this equivalence criteria may include protocol and packet information.

In some aspects, the present invention, upon carrying out the determination where the difference does not match the equivalence criteria, may report a spoofing attempt. In some aspects, the report can flag the discrepancy of the difference between location.

As will be appreciated, the directional sensor of the present invention may be configured to carry out the above method steps, and the present invention may encompass a method and apparatus for carrying out that method.

In some aspects, the step, to determine, for a given input signal a differential of a signal parameter between 2 or more of the aerials; the signal received at any given time instance may be compared in magnitude in the time domain, and differences in magnitude may reflect signal attenuation.

In some aspects, the differential of the signal parameter may be selected from reception signal strength. In some aspects, selecting from reception signal strength may be particularly useful when monitored over time such that, were a change of signal strength to not correspond to a changing distance of a micro aerial vehicle ADS-B signal reported position, then this can be used as an effective determinant of a spoofing attempt. In some aspects, selecting from reception signal strength may be particularly useful when a change in position, such as a combination of distance and angle of a reported position determined by an ADS-B closely corresponds with a signal direction determined over time but for which the spoofing places the micro aerial vehicle either nearer to or further away from the directional sensor.

In some aspects, the differential of the signal parameter may additionally or alternatively be selected from the time of arrival of the signal at the sensor. In some aspects, selecting from time of arrival may be by means cross-correlation as used to determine a time offset. In some aspects, selecting from time of arrival may be particularly useful when the time of arrival, compared to a departure time, e.g., a sending time of the ADS-B signal does not correspond to an expected arrival time, and this can be used as an effective determinant of a spoofing attempt. In some aspects, selecting from time of arrival may be particularly helpful in determining spoofing as it may enable differences in distance, even for an equivalent direction, of the source of a spoofing signal to not obscure a spoofing attempt.

In some aspects, the differential of the signal parameter may additionally or alternatively be selected from the phase angle of the signal. In some aspects, selecting from phase angle of the signal may be particularly useful in enhancing direction finding. In some aspects, phase differences of signals received at multiple aerials of the direction sensor may be a basis to determine the direction from which a signal is originating. In some aspects, selecting from phase angle of the signal may be used in applications like locating the source of a radio transmission.

In some aspects, the correlation of the differential signal parameter may determine a distance of the signal source from the aerial. In some aspects, as previously mentioned, reception signal strength and time of arrival may be particularly suitable for this determination.

In some aspects, the correlation of the differential signal parameter may additionally or alternatively determine a geographic location of the signal source. In some aspects, this may be particularly suitable for determination based upon changes in signal reception over time and the accuracy of determination. In some aspects, the use of a GPS as part of the directional sensor may also be advantageous in this respect as it provides a clear and unambiguous reference point. In some aspects, use of a GPS may provide an indication, at any given time, of the GPS error. In some aspects, while an incoming signal may appear to be spoofed in that there may be a mismatch between the ADS-B reported location and the location determined by signal reception, this in itself may be erroneous if there is significant disturbance in the GPS signal; therefore the signal parameter of location (i.e. a combination of direction and distance) may be more accurate than a GPS signal at any given time. On this basis, in some aspects, the GPS location determined by GPS of the location sensor may be repeatedly measured over time so as to progressively give a more accurate geographic location (e.g., if the sensor itself and with it the aerials are in a fixed position). Hence, in some aspects, the aggregated, more accurate geographic position (such as aggregated by an averaging process, which may the determination of an arithmetic mean) can be compared at any given time with natural GPS signal and this error mapped onto a narrow boundary for the ADS-B provided location. Hence, in some aspects, provided that the ADS-B location is within an error commensurate with the error determined from the directional sensor itself, then erroneous spoofing alerts can be avoided.

In some aspects, the correlation of the differential signal parameter may additionally or alternatively determine a height of the signal source from the aerial. In some aspects, this may be particularly useful in determining spoofing attempts as elevation may be a primary determinant of the type of traffic involved. For example, outside an airfield landing strip, conventional aerial vehicles, as opposed to micro aerial vehicles, may typically be present at low altitude, such as below 400 ft.

In some aspects, the correlation of the differential signal parameter may additionally or alternatively determine location in three dimensions of the signal source from the aerial.

In some aspects, the compare may provide one or more of: a) a difference in magnitude of one or more parameters, such as distance and angle; b) a rate of change, first differential, of one or more parameters, such as distance and angle; and c) a second differential, of one or more parameters, such as distance and angle. In some aspects, the rate of change may be particularly useful when compared to predetermined information for normal parameters for a micro aerial vehicle. For example, in some aspects, acceleration and speed can be compared to acceptable limits and, if outside those limits, a spoofing detection alert can be raised.

In some aspects, the compare may provide one or more of: a) a difference in magnitude of one or more parameters, such as distance and angle; b) a rate of change, first differential, of one or more parameters, such as distance and angle; and c) a second differential, of one or more parameters, such as distance and angle.

In some aspects, a signal attenuation means, in addition to air space, may be present between two or more of the one or more aerials.

In some aspects, the signal attenuation means may be a metal ground plane. In some aspects, an effective signal attenuation means may be provided in the form of a metal mesh having apertures in the order of 3 cm, such as apertures in the range 2 to 4 cm. In some aspects, this is on the boundary of effective microwave screening in the signal frequency relevant to ADS-B most relevant to the present invention namely 2.4 and 5 GHz. In some aspects, the present invention may be configured to selectively receive, and process, signals at one or both of these frequencies. In some aspects, such a metal ground plane may be configured for selective activation by means of grounding or being left floating (i.e. unattached to any electrical reference). In some aspects, this may enable the signal attenuation effect to be rapidly varied such as to assist in confirmation of a signal direction determination.

In some aspects, the signal attenuation means may be a ferrite sheet or a conductive plastics sheet. In some aspects, such signal attenuation means may be advantageous in that they can be configured to provide partial signal attenuation. This may enable the direction of reception of a signal to be readily determined by checking for a given signal which aerial receives the strongest reception, and the intervening signal attenuation means attenuating the signal may provide a clear differential in signal strength between aerials. In some aspects, this may be particularly useful with micro aerial vehicles where a signal source may be very close and hence signal strength high, and therefore the linear portion of an amplified signal as in linear correlation between distance and strength may be distorted. In some aspects, this situation may be overcome by use of the partial signal attenuation where a clear differential in signal strength may be created between two closely spaced aerials.

In some aspects, the signal attenuation means may provide no line of sight between adjacent aerials. In some aspects, this may be useful as it may enable a clear receive/no receive determination to enable the direction of the signal to be rapidly determined.

In some aspects, the plurality of aerials may be four aerials mounted in a rectangular array. While in principle the present invention includes a plurality of aerials receiving a signal, four aerials mounted in a rectangular array may be optimal in providing directional resolution combined with economy of construction, particularly in the required frequency bands of 2.4 and 5 GHz. In some aspects, having more than four aerials may not necessarily be advantageous because, for a given signal, while a signal duration for an ADS-B may be in the order of ms, a drone passing at speed in close proximity may not expose an aerial to an incoming signal long enough to receive a complete signal if the receiver is highly segmented so that each aerial is exposed to a narrow segment of radio traffic.

In some aspects, a cruciform signal attenuation means may be present between the aerials. In some aspects, a cruciform signal attenuation means may have an extruded X shape having 5 axes of symmetry.

In some aspects, the aerials may be in a known and fixed proximity to a GPS sensor which is in communication with the processor for providing a location of the aerials to the processor.

In some aspects, the GPS sensor may be located between two or more of the aerials. In some aspects, this may be advantageous in that it may better approximate the overall geographic position of the aerials as it is located centrally with respect to the aerials. In this aspect, there is advantage when the aerials are positioned around a horizontal periphery of the GPS sensor so that the aerials act to shield the GPS receiver from near horizon GPS signals, which are generally the least accurate signals. This may give more accurate GPS readings of the aerial position. The aerial position is useful in determining the relative position of a drone and from that evaluating a potential spoofing attempt.

In some aspects, the signal attenuation means may include an aperture for reception of radio signals by the GPS sensor. In some aspects, this may improve the shielding from low angle, horizon, GPS signals. Because the directional sensor of the present invention may be configured in a stationary position, then the lack of GPS signals, i.e. there being less occasions, such as in a given time period, when necessary four satellites to determine GPS position are visible is not a disadvantage. However, in some aspects, for a stationary directional sensor, accurate determination may be more important than frequency of determination.

In some aspects, the present invention may be used in situations in which the GPS receiver might have difficulty receiving signals from four or more satellites (e.g., high-density urban situations where larger scale antennas are not practical, urban canyons, or areas with obstructions). In such situations, the accuracy of the GPS reading could be compromised. Therefore, in some aspects, advanced GPS receivers and systems may be used. This aspect may incorporate Differential GPS (DGPS) or Real-Time Kinematic (RTK) corrections to enhance accuracy even further.

In some aspects, the GPS sensor may be orientated in relation to the aperture such that an angle (e.g., a 45° angle or, more generally, an angle in the range of 50° to 25°) to the vertical (i.e. defining a notional cone of reception) is available to the GPS sensor where it is not shielded by the attenuation means. In some aspects, the angle may be in a range of 40 to 50°. In some aspects, the angle may be 45°. In some aspects, the angle may enable the directional sensor of the present invention at any given position on Earth's surface to simultaneously have access to four satellites within a 45° range of the vertical multiple, such as 10 to 12 times a day. In some aspects, for a static directional sensor, this may be adequate, and these accurate measurements can be correlated over time to give an even more precise position determination. This may therefore provide an ideal reference for transitory GPS signals determined at any given time to, as mentioned, provide an indication of GPS error over ideal.

In some aspects, the directional sensor of the present invention may have access to two GPS signal determinations, which may be shielded and unshielded determinations. In some aspects, a shielded determination, which may be more accurate though available less frequently than the unshielded determination, may be representative of a position determination from a micro aerial vehicle, such as sending in an ABS-B signal to the directional sensor. In some aspects, this access may be provided by using a switchable signal attenuation which means, which can be switched on and off by the provision of two GPS devices, one within the aperture and another outside the aperture.

In some aspects, the aperture may be perpendicular to vertical faces of the signal attenuation means. In some aspects, this may be in the context of a signal attenuation means in a directional sensor of the present invention, and the notional angles to the vertical mentioned previously may be in reference to this perpendicular with respect to the directional sensor of the present invention when installed in a fixed position.

In some aspects, to mitigate the issue of reflections causing false positives/false spoofing scenarios, the sensor can be linked as part of an array of sensors that can be placed strategically in the environment to mitigate this issue. In some aspects, the array of sensors can compare and combine RSSI values to determine the possibility of spoofing and or reflections of signals.

In some aspects, a ground/shielding plane can be modified through the application of RF absorption sheets/materials. This may have the benefit to reduce the effect of reflections from the shielding planes themselves.

In some aspects, by using an array of directional antennas and by recording the RSSI (Relative signal strength indicator) of detections, the directional sensor of the present invention may be able to detect and prevent ‘spoofing’ of drone locations on a map. ‘Spoofing devices’ may send packet information of a drone's location to place drones in false locations.

For instance, in some aspects, if the sensor receives a packet of data placing a drone to the south of the sensor, the present invention may check the RSSI and, if the directional antenna pointing south has the greatest value amongst the rest of the directional antennas, it can be assumed that the information is correct and not ‘spoofed’. However, in some aspects, if the directional antenna pointing south does not have the greatest RSSI value but rather another directional antenna does (for instance one pointing North), it can be assumed that the signal of the drone is not coming from where the packet information is indicating the drone is and thus is spoofed.

Further variations encompassed within the apparatuses and methods are described in the detailed description of the invention below.

### BRIEF DESCRIPTION OF THE DRAWINGS

The accompanying drawings, which are incorporated herein and form part of the specification, illustrate various, non-limiting aspects of the present invention. In the drawings, like reference numbers indicate identical or functionally similar elements.

FIG. 1 shows an aerial arrangement suitable for use in a directional sensor according to some aspects.

FIG. 2 shows the aerial arrangement of FIG. 1 further including a planar shielding member in the form of a cross according to some aspects.

FIGS. 3A and 3B show schematic representations of the aerial arrangement of FIGS. 1 and 2, respectively, according to some aspects.

FIG. 4 shows a schematic of a spoofing attempt by a drone upon a directional sensor according to some aspects.

FIG. 5 shows a schematic of the effect of planar shielding from FIG. 2 in the context of the schematic of FIG. 4 according to some aspects.

FIG. 6 shows a schematic of the effect of a selective planar shielding from FIG. 2 in the context of the schematic of FIG. 4 according to some aspects.

FIG. 7 shows the aerial arrangement of FIG. 1 further comprising a planar shielding member in the form of a cross with a central cylindrical aperture according to some aspects.

FIG. 8 shows the aerial arrangement of FIG. 1 further including a planar shielding member in the form of a cross with a central rectangular channel according to some aspects.

FIG. 9 shows the aerial arrangement of FIG. 1 further including a planar shielding member in the form of rectangular channel with faces planar to the aerials according to some aspects.

FIG. 10 shows the aerial arrangement of FIG. 1 further including a planar shielding member in the form of a cylindrical member according to some aspects.

FIG. 11 shows the aerial arrangement of FIG. 1 further including a planar shielding member in the form of a rectangular channel with faces at 45° to the basis of the aerials according to some aspects.

### PARTS LIST

100 Directional sensor assembly

110 Base

140 Aerial

140S Shielded Aerial

150 Aerial Element

160 Drone

170 Spoofed Drone Position

180 Schematic

200 Cross Cylinder Shield

210 Cross Cylinder wing

215 Cross Cylinder core

220 Cross Cylinder aperture

230 Cross Cylinder join

300 Cross

310 Cross wing

310G Activated, Grounded, Cross wing

320 Cross join

330 Further Cross wing

330F Deactivated, Ungrounded, Floating Cross wing

400 Cross Tube Shield

410 Cross Tube wing

415 Cross Tube core

420 Cross Tube aperture

430 Cross Tube join

500 Cuboid Shield

515 Cuboid core

520 Cuboid aperture

530 Cuboid join

600 Cylindrical Shield

615 Cylindrical core

620 Cylindrical aperture

700 Offset Cuboid Shield

715 Offset Cuboid core

720 Offset Cuboid aperture

730 Offset Cuboid core join

### DETAILED DESCRIPTION

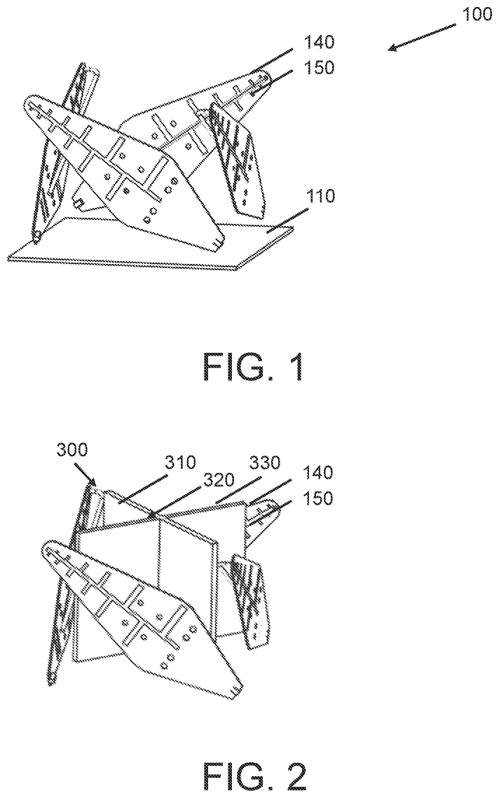

FIG. 1 shows an aerial arrangement suitable for use in the directional sensor 100 according to some aspects of the present invention. In some aspects, the sensor may include a base 110. In some aspects, the base 110 may be a printed circuit board upon which circuitry for providing control, analysis and communication of the device is mounted.

In some aspects, as shown in FIG. 1, the directional sensor 100 may include four aerials 140. In some aspects, the aerials 140 may have the angles to the vertical mentioned below. In some aspects, each aerial 140 may be a multi-element log periodic dipole array and may be electrically connected to the base 110 where amplification and signal conditioning may be located. In some aspects, as shown in FIG. 1, the aerials 140 may include aerial elements 150.

In some aspects, the aerials 140 may be located such that the planes do not overlap, thus most efficiently harvesting electromagnetic signals in the space available.

In some aspects, the directional sensor 100 may have more than or fewer than four aerials 140. In some aspects having more than four aerials 140, high resolution can be obtained. In some aspects, the directional sensor 100 may have four aerials 140 because it has been found that, in practice, four aerials 140 provide a good compromise between the angular resolution of signal direction and space utilization.

In some aspects, a GPS sensor may be mounted centrally on the circuit board of the base 110. In some aspects, the GPS sensor may be configured to determine the location of the directional sensor 100. In some aspects, the directional sensor may be fixed in a given position, and the ongoing obtaining of GPS signals and the evaluation of those signals to determine a geographic location may be beneficial. In particular, by obtaining, such as daily, a GPS position then, cumulatively, over time, an extremely accurate geographic position can be established by interpolating, such as by averaging, the various position readings. Hence, repeated GPS location acquisition for a fixed device is beneficial.

In some aspects, the GPS sensor may be configured to determine the location of the directional sensor 100 on a frequent basis, such as hourly, and, upon each determination, to compare this with a reference position (such as the accurate position mentioned above) so as to determine the level of noise in the GPS environment. Specifically, some aspects of the present invention may be concerned with the question of spoofing, that is whether an aerial vehicle, or other source, is providing inaccurate information regarding position, as compared to an actual position of the source of the signal. In some aspects, determining the level of noise in the GPS environment, such as determined and error between actual and determined GPS location of the directional sensor 100, can be used to enhance the evaluation of spoofing. For example, electromagnetic disturbance in the atmosphere during electrical storms can potentially affect GPS signals due to increased ionization in the ionosphere caused by lightning activity. This ionization can lead to signal delays and disruptions. Thus, in some aspects, to prevent erroneous determinations of spoofing, the directional sensor 100 may change a threat foothold for spoofing determination dependent upon system error, but error may be consolidated such as in a measure as indicated above, for example by means of a horizontal dilution of precision (HDOP) value.

Horizontal Dilution of Precision (HDOP) is a measure of the geometric quality of satellite positioning signals. It provides an indication of the accuracy of horizontal (latitude and longitude) positioning based on the distribution and arrangement of the satellites in view. HDOP is a dimensionless value that reflects the potential error introduced into a position calculation due to poor satellite geometry.

In some aspects, HDOP may be calculated using the positions of visible satellites relative to the user's position. The formula for HDOP involves the positions of the satellites and their corresponding measurement uncertainties. In some aspects, HDOP may be calculated as follows: HDOP=sqrt((σ_x\hat{ }2+σ_y\hat{ }2)/σ_z\hat{ }2), where: σ_x is the standard deviation of satellite positions in the East-West direction, σ_y is the standard deviation of satellite positions in the North-South direction, and σ_z is the standard deviation of satellite positions in the vertical direction. In some aspects, HDOP may take into account the spread of satellites in the sky relative to your position. In some aspects, a lower HDOP value may indicate better satellite geometry and thus higher accuracy.

In some aspects, the threshold for alerting spoofing may be adapted (such as in real time) based upon the HDOP of the directional sensor 100. In some aspects, the threshold for alerting spoofing may be adapted according to the following classifications: HDOP<1 (excellent accuracy), HDOP between 1 and 2 (good accuracy), HDOP between 2 and 5 (fair accuracy), and HDOP>5 (poor accuracy). In some aspects, when HDOP<1 (excellent accuracy), all mismatches between purported and determined position of an aerial object being tracked differing by more than 1 m may be signaled as spoofing. In some aspects, when HDOP is between 1 and 2 (good accuracy), mismatches between purported and determined position of an aerial object being tracked differing by more than 4 m may be signaled as spoofing. In some aspects, when HDOP is between 2 and 5 (fair accuracy), mismatches between purported and determined position of an aerial object being tracked differing by more than 16 m may be signaled as spoofing. In some aspects, when HDOP>5 (poor accuracy), mismatches between purported and determined position of an aerial object being tracked differing by more than 50 m may be signaled as spoofing.

In some aspects, the threshold for alerting spoofing may be adapted (such as in real time) based upon the HDOP of the directional sensor 100 and a difference in reception angle (e.g., angle as in general and 60° points of the compass), which may in practice be more reliable than HDOP alone. In some aspects, the following scheme may be used for alerting spoofing: (1) when HDOP<1 (excellent accuracy), all mismatches between purported and determined angle of signal arrival of an aerial object being tracked differing by more than 1 m may signaled as spoofing,. (2) when HDOP is between 1 and 2 (good accuracy), mismatches between purported and determined angle of signal arrival of an aerial object being tracked differing by more than 4 m may be signaled as spoofing, (3) when HDOP is between 2 and 5 (fair accuracy), mismatches between purported and determined angle of signal arrival of an aerial object being tracked differing by more than 16 m may be signaled as spoofing, (4) when HDOP>5 (poor accuracy), mismatches between purported and determined angle of signal arrival of an aerial object being tracked differing by more than 50 m may be signaled as spoofing. In some aspects in which the threshold for alerting spoofing is adapted based upon HDOP and the difference in reception angle, while resolution at distance may in principle be poorer than resolution at close range, ranges which are often more pertinent for micro aerial vehicles are improved, and more reliable spoof detection may be provided.

In some aspects, the base 110 may include processing equipment, such as a processor, memory and communications equipment, configured to carry out the tasks identified herein. In some alternative aspects, the equipment as a whole, but not the base 110, may include processing equipment, such as a processor, memory and communications equipment, configured to carry out the tasks identified herein. In some aspects, the equipment may be externally powered.

In some four antenna array aspects, as shown in FIG. 1, the four antenna design can be considered either ‘off centre’ or facing perpendicular to the side of the sensor 100 they are placed upon. This may provide a space efficient directional sensor and/or one which may conveniently fit within the space limitations, such as the footprint allowed of a standardized mobile casing.

FIG. 2 shows the aerial arrangement of FIG. 1 further including a planar shielding member 300 according to some aspects. In some aspects, as shown in FIG. 2, the planar shielding member 300 may be in the form of a cross. In FIG. 2, and in subsequent figures, the base 110 is not depicted so as to aid clarity. In some aspects, as shown in FIG. 2, the directional sensor 100 may include the previously identified aerials 140 with antenna elements 150 (e.g., four aerials 140), and placed between the aerials 140 is electromagnetic shielding 300. In some aspects, the shielding 300 is in the form of an extruded cross. In some aspects, the shielding 300 may be oriented in the vertical direction) here extruded in what is termed a principal elongate axis (axis for short). In some aspects, the axis of the shielding 300 may be at an angle to the principal axis of the aerial elements 150 that is between, for example, 20 and 60°, between 30 and 50°, or between 44 and 46°. As mentioned, in some aspects, the axis of the shielding 300 may be typically vertically orientated, and this may provide an optimal angle for a small number of aerials 140 to detect micro aerial vehicles. This is been found in practice to be optimal because, unlike conventional aerial vehicles, flight is at low altitudes, often at altitudes commensurate with the height positioning of the directional sensor. While some aspects may include a larger number of aerials, more than four aerials may be less efficient.

In some aspects, electromagnetic shielding 300 may include planar sheets of material in the form of crosswings 310 converging at cross joint 320. In some aspects, as shown in FIG. 2, the electromagnetic shielding 300 may be electrically connected at cross joint 320. This may enable efficient space utilization together with a shape of strong physical integrity. In some aspects, the electromagnetic shielding 300 may be supported at a lower edge of the electromagnetic shielding 300 attached to the base 110. In some aspects, the lower edge of the electromagnetic shielding 300 may be attached to the base 110 by means of attachment to a printed circuit board forming the base 110. In general, shielding of antennas with ground planes in aspects of the present invention has been found to improve the RSSI reliability.

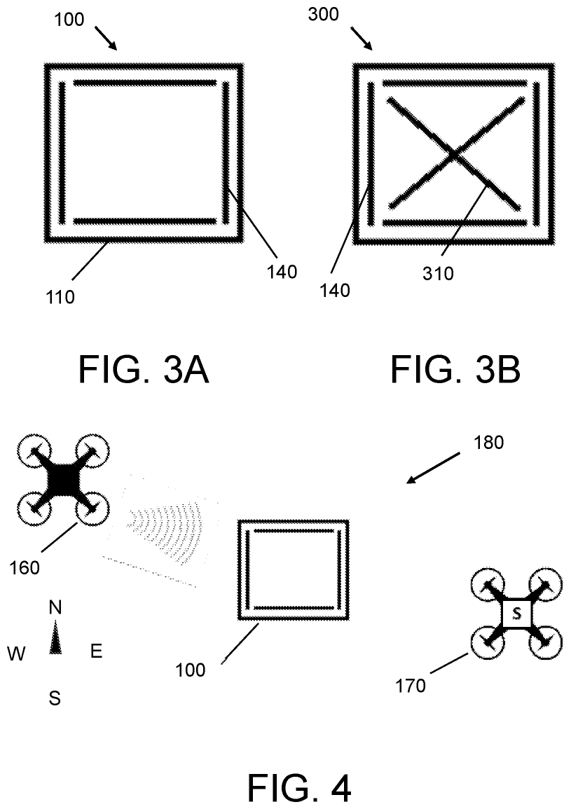

FIGS. 3A and 3B show schematic representations of the aerial arrangement of FIGS. 1 and 2, respectively, according to some aspects. The schematics of FIGS. 3A and 3B are to be understood in conjunction with FIGS. 1 and 2, respectively. These schematics are then used in FIG. 4.

FIG. 4 shows a schematic of a spoofing attempt by a drone upon a directional sensor 100 according to some aspects. In some aspects, the directional sensor 100 detects a radio signal from a drone 160, this for example being a micro aerial vehicle, north-west of the sensor 100. The drone provides an Automatic Dependent Surveillance-Broadcast (ADS-B). The information from which would normally correspond to information corresponding to its best-known position. However, in a spoofing attempt, the ADS-B position corresponds to that of spoofed drone position 170 south-east of the sensor 100. In some aspects, by correlating the received information and the direction of the received information and extracting from these the relevant position, the disparity between the two positions is used by the directional sensor 100 to detect a spoofing attempt and for this then to be reported.

In some aspects, the directional sensor 100 may be configured to detect a purported position ADS-B that corresponds to received signal direction but is either further away or nearer than the sender location. In some aspects, the sensor 100 may be configured to detect this by comparing the movement in the purported position over time with either or both of: (a) the signal strength and (b) the correspondence of the angle change with purported change in distance as compared to typical speed parameters for the type of vehicle. With respect to comparing the movement in the purported position over time with the signal strength, while the absolute value of signal strength may be unknown and therefore is not itself a marker of distance, the diminution of signal strength with changing distance is known, and, in some aspects, the correlation of expecting signal strength change with distance to the actual signal/change with distances can paired, and, where a mismatch is determined, then a spoofing attempt can be reported. With respect to comparing the movement in the purported position over time with the correspondence of the angle change with purported change in distance as compared to typical speed parameters for the type of vehicle, for example, in some aspects, the sensor 100 may be configured such that detecting a micro aerial vehicle that a speed between one and 20 m/s is to be expected, but a micro aerial vehicle changing emitted signal angle of 3° over a period of one minute can be no further than 1200 m away or the sensor 100 will report a spoofing attempt.

In some aspects, both methods (a) and (b) are combined in the determination of a spoofing attempt. In some aspects in which methods (a) and (b) are combined, expected changes signal compared to expected movement velocity are compared to preconfigured values for a micro aerial vehicle, and a change outside an expected range is reported as a spoofing attempt. This may be particularly useful in that a purported location which changes by 3° over the period of one minute but for which there is a signal increase of 2% in that time indicates that even faster movement must be present as the micro aerial vehicle is moving towards the observer and as such the directional sense of the present invention reports a spoofing attempt with a higher confidence level.

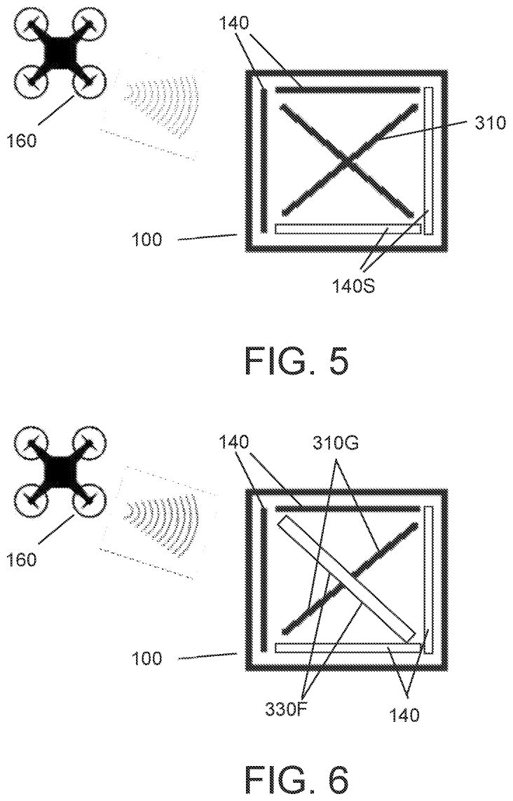

FIG. 5 shows a schematic of the effect of planar shielding 300 from FIG. 2 in the context of the schematic of FIG. 4.

Directional signal information may be obtained by a directional sensor 100 in a manner known in the art. In some aspects, signals may be determined by a plurality of aerials 140, and the signal strength determined by an aerial 140 can be correlated to an angle of incidence. However, system sensitivity may be increased by shielding signals from other directions, and, in this respect, in some aspects of the present invention, the directional sensor 100 may further include, in addition to aerials 140, signal attenuation means 300. In some aspects, the signal attenuation means 300 may act by shielding some of the plurality of aerials 140 from an incoming signal so as to unambiguously determine signal direction. In FIG. 5, the shield aerials are shown as 140S. In some aspects, the signal attenuation means 310 may provide no line of sight between adjacent aerials 140 and therefore provide improved selectivity to an incoming signal as a function of direction. However, a signal difference as shown in FIG. 4 is still possible to be spoofed within the error margins of a small antenna array as the spoofed position could be determined to have arisen from its purported direction provided at the alternative direction is on a plane of symmetry of the incoming signal and 180° away from the signal source. In some aspects, this can be overcome by the use of signal attenuation means 300 where two of the four aerials 140 can receive the signal and two of the four aerials 140 (i.e., aerials 140S) are shielded from the signal. This provides a more accurate and efficient directional sensor 100 having a limited number of aerials 140, such as a number of aerials from 3 to 6 (e.g., 4 aerials).

FIG. 6 shows a schematic of the effect of a selective planar shielding 300 from FIG. 2 in the context of the schematic of FIG. 4. In some aspects, the directional signal sensor 100 may use a selectively activated signal attenuation means 300. In some aspects, as shown in FIG. 6, the extruded across 300 attenuation means has two of the wings 310G selectively activated, for example by grounding, and two wings 330F selectively deactivated, for example by having been floating relative to ground. In some aspects, selective activation and deactivation of wings 310 may enable selective combination of aerials 140 to be presented to an incoming signal for the optimization and checking of an incoming signal and angle. In some aspects, the sensor 100 may be configured to control the attenuation means 300 so as to present different combinations of aerials 140 to an incoming signal and thereby selectively detect that signal and specifically excluding potential incoming directions of the signal from the required determination. In some aspects, the sensor 100 may thereby increase the accuracy as limits to the range of incoming signal detected are therefore achieved.

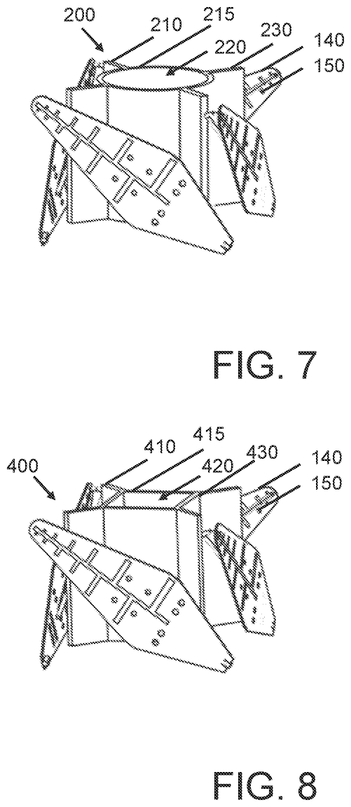

FIG. 7 shows the aerial arrangement of FIG. 1 further including a planar shielding member 200 in the form of a cross with a central cylindrical aperture 220. In some aspects, a central aperture 220 may be presented such that the signal attention means 200, being selective or otherwise, shields the antenna 140 so that the antenna elements 150 are shielded from incoming signal. In some aspects, the signal attenuation means 200 may include wings 210 to turn akin to those in the extruded cross 300 with the further addition of cylinder core 215 enclosing aperture 220. In some aspects, the cross cylinder wings 210 of the signal attenuation means 200 may be joined by a cross cylinder join 230. In some aspects, the signal attenuation means 200 may have the advantage that a GPS tracking device can be located within aperture 220 and shielded from lateral incoming signals, such as signals which may be designed to disrupt the incoming signal. In some aspects, the height of the signal attenuation means 200 may be varied along with the depth of the GPS receiver within the aperture 220 such that a suitable portion of the sky maybe available for signal reception. In some aspects, this may have the advantage that, without any modification, such as in processing or programming, only GPS signals with low directional precision, such as HDOP (Horizontal Dilution of Precision) and/or VDOP (Vertical Dilution of Precision), can affect positioning accuracy, can be minimized. In some aspects, while restricting the angle of view of GPS signals is usually considered disadvantageous, directional centers of the present invention may typically be secured, or are secured in a fixed location, and therefore time determination of GPS position is not a factor where hours accuracy is. Hence, the signal attenuation means 200 may enable the most accurate GPS signals to be achieved by restricting the incoming GPS satellite signals which may be used in the GPS determination. Hence, what is normally a negative or undesirable feature for a GPS signal may be used by the sensor 100 for benefit. While GPS receivers are capable of receiving signals at low angles close to the horizon, this might result in decreased accuracy and potential signal blockage due to obstacles like buildings, trees, and terrain, and this may be avoided by the some aspects including the signal attenuation means 200.

FIG. 8 shows the aerial arrangement of FIG. 1 further including a planar shielding member 400 in the form of a cross with a central rectangular channel 420. In some aspects, the planar shielding member 400 may include cross tube wings 410 and a cross tube core 415, which may include a cross tube aperture 420 and a cross tube join 430. In some aspects, the planar shielding member 400 shown in FIG. 8 may achieve the aforementioned advantages of the planar shielding member 200 shown in FIG. 7 with respect to the shielding of the aerials 140 one from another, but the planar shielding member 400 may have a larger core 415 because the core 415 for a given distance away from an aerial 140 encompasses a larger area and therefore permits a greater GPS signal providing a better compromise for a four aerial array with GPS to both encompass shielding and central GPS access. In some aspects, the cross tube core wings 410 of the cross tube shield 400 may be joined by the cross tube join 430. For both the arrangements of FIGS. 7 and 8, centrally placing the GPS may give the highest potential for accuracy relative to the position of the aerials 140. In some aspects, the GPS detector may for example be located on a printed circuit board forming the base 110 of the detector 100.

In summary, in some aspects, the use of the shielded signal attenuation means 200 or 400 may provide for GPS that satellite signals received at higher angles (closer to overhead) which pass through less of the Earth's atmosphere are preferentially received, reducing the potential for signal degradation due to atmospheric effects such as ionospheric delay and multipath interference. As the angle decreases and the signals approach the horizon, the signals pass through a thicker portion of the atmosphere, potentially encountering more atmospheric disturbances that could affect accuracy, and these signals are shielded from reception. While reducing GPS satellite signals may be counterintuitive, it enables pre-existing pre-configured sensors which are normally configured to solely establish a reading when sufficient satellites are detected to be used more effectively by shielding it from the more ineffective readings.

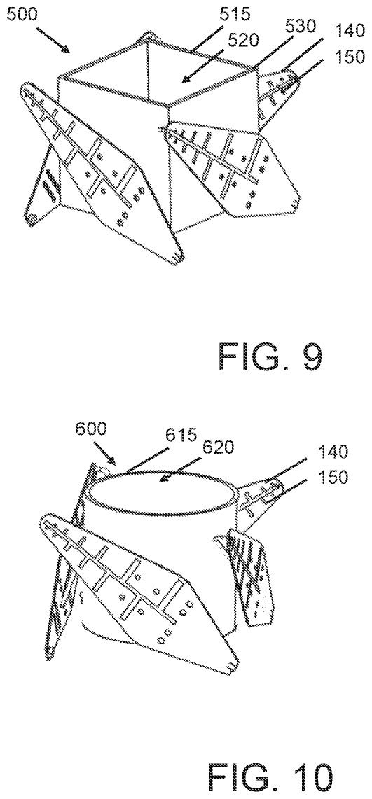

FIG. 9 shows the aerial arrangement of FIG. 1 further including a planar shielding member 500 in the form of rectangular channel 520 with faces of cuboid core 515 planar to the aerials 140. In some aspects, the planar shielding member 500 may include a cuboid join 530. In some aspects, this arrangement of the shielding means 500 may be advantageous in situations where the area accessible to receive signals by the GPS antenna must be maximized due to the large area of aperture 520 in comparison to the aerial encompassed by the aerials 140 with elements 150. In some aspects, this arrangement may be advantageous particularly in built-up areas, such as with high-rise buildings surrounding the directional sensor 100 while shielding of the aerials 140 one from another so as to improve directional accuracy is still maintained.

FIG. 10 shows the aerial arrangement of FIG. 1 further including a planar shielding member 600 in the form of a cylindrical member. In some aspects, the shielding member 600 may include a cylindrical core 615 surrounding a cylindrical aperture 620. In some aspects, the shielding member 600 may give less efficient aerial to aerial shielding but is direction agnostic and therefore enables more efficient mounting of the directional sensor 100 and may be in particular useful where the directional sensor 100 is mobile.

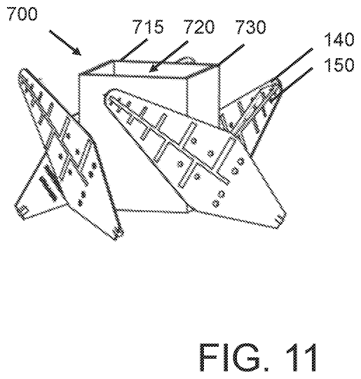

FIG. 11 shows the aerial arrangement of FIG. 1 further including a planar shielding member 700 in the form of a rectangular channel 720 with faces at 45° to the basis of the aerials 140. In some aspects, this arrangement may be particularly useful in areas with low signal intensity, such as in more rural areas where micro-aerial vehicles may need to be detected over a wider area. In some aspects, the faces of the attenuation means 700 may be in the form of a tubular cuboid core 715 enclosing an aperture 720. In some aspects, the planar shielding member 700 may include an offset cuboid core join 730. In some aspects, the shielding between aerials provided by the planar shielding member 700 may be less effective, but the planar shielding member 700 may provide maximal overall signal reception area for a given real estate area of signal reception while enabling potential reflection from faces 715 back to the aerials 140.

In some aspects, a further function of the attenuation mean may be to help isolate noise generated from the internal components of the sensor 100 (e.g., PSU, buck converters, and/or signal generators).

While various aspects are described herein, it should be understood that they have been presented by way of example only, and not limitation. Thus, the breadth and scope of this disclosure should not be limited by any of the above-described exemplary aspects. Moreover, any combination of the above-described elements in all possible variations thereof is encompassed by the disclosure unless otherwise indicated herein or otherwise clearly contradicted by context.

What is claimed is:

1. A directional sensor for receiving and evaluating location signals from aerial vehicles relative to the directional sensor, the directional sensor comprising:
aerials; and
a processor configured to:
a) determine for a signal from an aerial vehicle a differential of a signal parameter between two or more of the aerials;
b) operate on the differential of the signal parameter to determine a position relative to the aerials by means of a correlation or covariance;
c) compare the determined position relative to the aerials with a reported position of the aerial vehicle;
d) determine a difference between the reported and determined positions and compare the difference to equivalence criteria; and
e) report a spoofing attempt upon determining that the difference does not match the equivalence criteria.

2. The directional sensor of claim 1, wherein the differential of the signal parameter is selected from one or more of:
a) reception signal strength;
b) time of arrival of the signal at the directional sensor; and
c) phase angle of the signal.

3. The directional sip sensor of claim 1, wherein the correlation of the differential of the signal parameter determines one or more of:
a) a distance of the aerial vehicle from the aerials;
b) a geographic location of the aerial vehicle;
c) a height of the aerial vehicle from the aerials; and
d) a location in three dimensions of the aerial vehicle from the aerials.

4. The directional sensor of claim 1, wherein comparing the difference to the equivalent criteria provides one or more of:
a) a difference in magnitude of one or more parameters;
b) a first differential rate of change of the one or more parameters; and
c) a second differential of the one or more parameters.

5. The directional sensor of claim 4, wherein the one or more parameters include distance.

6. The directional sensor of claim 5, wherein the one or more parameters include angle.

7. The directional sensor of claim 4, wherein the one or more parameters include angle.

8. The directional sensor of claim 1, further comprising a signal attenuation means, in addition to air space, between two or more of the aerials.

9. The directional sensor of claim 8, wherein the signal attenuation means is a metal ground plane.

10. The directional sensor of claim 8, wherein the signal attenuation means is a ferrite sheet or a conductive plastics sheet.

11. The directional sensor of claim 8, wherein the signal attenuation means provides no line of sight between adjacent aerials.

12. The directional sensor of claim 1, wherein the aerials comprise four aerials mounted in a rectangular array.

13. The directional sensor of claim 12, further comprising a cruciform signal attenuation means between the aerials.

14. The directional sensor of claim 1, further comprising a GPS sensor, wherein the aerials are in a known and fixed proximity to the GPS sensor, and the GPS sensor is in communication with the processor for providing a location of the aerials to the processor.

15. The directional sensor of claim 14, wherein the GPS sensor is located between two or more of the aerials.

16. The directional sensor of claim 15, further comprising a signal attenuation means, in addition to air space, between two or more of the aerials, and the signal attenuation means comprises an aperture for reception of radio signals by the GPS sensor.

17. The directional sensor of claim 16, wherein the aperture is perpendicular to vertical faces of the signal attenuation means.

18. A method for receiving and evaluating location signals from aerial vehicles relative to a directional sensor, the method comprising:
a) using a processor of the directional sensor to determine for a signal from an aerial vehicle a differential of a signal parameter between two or more of aerials of the directional sensor;
b) using the processor of the directional sensor to operate on the differential of the signal parameter to determine a position relative to the aerials by means of a correlation or covariance;
c) using the processor of the directional sensor to compare the determined position relative to the aerials with a reported position of the aerial vehicle;
d) using the processor of the directional sensor to determine a difference between the reported and determined positions and compare the difference to equivalence criteria; and
e) using the processor of the directional sensor to report a spoofing attempt upon determining that the difference does not match the equivalence criteria.
